(19) United States
(12) Patent Application Publication
(10) Pub. No.: US 2021/0133469 A1
(43) Pub. Date: May 6, 2021

(54) NEURAL NETWORK TRAINING METHOD AND APPARATUS, GAZE TRACKING METHOD AND APPARATUS, AND ELECTRONIC DEVICE

(71) Applicant: Beijing SenseTime Technology Development Co., Ltd., Beijing (CN)

(72) Inventors: Fei WANG, Beijing (CN); Shiyao HUANG, Beijing (CN); Chen QIAN, Beijing (CN)

(21) Appl. No.: 17/145,795

(22) Filed: Jan. 11, 2021

Related U.S. Application Data
(63) Continuation of application No. PCT/CN2019/092131, filed on Jun. 20, 2019.

(30) Foreign Application Priority Data
Sep. 29, 2018 (CN) 201811155578.9

(51) Int. Cl. G06K 9/00; G06T 7/73; G08B 21/18

(52) U.S. Cl. CPC G06K 9/00845; G06T 7/73; G06K 9/00228; G08B 21/18; G06K 9/6262; G06T 2207/30201; G06T 2207/20081; G06T 2207/20084; G06T 2207/10016

(57) ABSTRACT

A neural network training method and apparatus, a gaze tracking method and apparatus, and an electronic device are provided. The neural network training method includes: determining a first gazing direction according to a first camera and a pupil in a first image, wherein the first camera is a camera for photographing the first image, and the first image at least includes an eye image; detecting, by means of a neural network, a gazing direction of the first image to obtain a first detected gazing direction; and training the neural network according to the first gazing direction and the first detected gazing direction.

### CROSS REFERENCE TO RELATED APPLICATION

This is a continuation application of International Patent Application No. PCT/CN2019/092131, filed on Jun. 20, 2019, which claims priority to Chinese Patent Application No. 201811155578.9, filed on Sep. 29, 2018. The content of the International Patent Application No. PCT/CN2019/092131 and the Chinese Patent Application No. 201811155578.9 are incorporated herein by reference in their entireties.

### BACKGROUND

Gaze tracking has an important function in applications such as driver monitoring, human-machine interaction and security monitoring. Gaze tracking is a technology for detecting the gaze direction of the human eyes in a three-dimensional space. In terms of human-machine interaction, the position of a person's gaze point in a three-dimensional space is obtained by locating the three-dimensional positions of the human eyes in space in combination with the three-dimensional gaze direction, and output to a machine for further interaction processing. In terms of attention test, a region of interest of a person is obtained by estimating the gaze direction of the human eyes and determining the person's gaze direction, so as to determine whether the attention of the person is focused.

### SUMMARY

The present application relates to the field of computer technologies, and in particular, to a neural network training method and apparatus, a gaze tracking method and apparatus, an electronic device, and a computer-readable storage medium.

The present application provides technical solutions for neural network training and technical solutions for gaze tracking.

In a first aspect, embodiments of the present application provide a neural network training method, including:

determining a first gaze direction according to a first camera and a pupil in a first image, where the first camera is a camera that captures the first image, and at least an eye image is included in the first image includes;

detecting a gaze direction in the first image through a neural network to obtain a first detected gaze direction; and

training the neural network according to the first gaze direction and the first detected gaze direction.

In a second aspect, the embodiments of the present application provide a gaze tracking method, including:

performing face detection on a third image included in video stream data;

performing key point positioning on a detected face region in the third image to determine an eye region in the detected face region;

capturing an image of the eye region in the third image; and

inputting the image of the eye region to a pre-trained neural network and outputting a gaze direction in the image of the eye region.

In a third aspect, the embodiments of the present application provide a neural network training apparatus, including:

a first determination unit, configured to determine a first gaze direction according to a first camera and a pupil in a first image, where the first camera is a camera that captures the first image, and at least an eye image is included in the first image includes;

a detection unit, configured to detect a gaze direction in the first image through a neural network to obtain a first detected gaze direction; and

a training unit, configured to train the neural network according to the first gaze direction and the first detected gaze direction.

In a fourth aspect, the embodiments of the present application provide a gaze tracking apparatus, including:

a face detection unit, configured to perform face detection on a third image included in video stream data;

a first determination unit, configured to perform key point positioning on a detected face region in the third image to determine an eye region in the detected face region;

a capture unit, configured to capture an image of the eye region in the third image; and

an input/output unit, configured to input the image of the eye region to a pre-trained neural network and output a gaze direction in the image of the eye region.

In a fifth aspect, the embodiments of the present application further provide an electronic device, including a processor and a memory, where the memory is adapted to be coupled to the processor and is used for storing program instructions, and the processor is configured to support the electronic device to implement corresponding functions in the method according to the above first aspect.

Optionally, the electronic device further includes an input/output interface, and the input/output interface is configured to support communication between the electronic device and other electronic devices.

In a sixth aspect, the embodiments of the present application further provide an electronic device, including a processor and a memory, where the memory is adapted to be coupled to the processor and is used for storing program instructions, and the processor is configured to support the electronic device to implement corresponding functions in the method according to the above second aspect.

Optionally, the electronic device further includes an input/output interface, and the input/output interface is configured to support communication between the electronic device and other electronic devices.

In a seventh aspect, the embodiments of the present application further provide a gaze tracking system, including a neural network training apparatus and a gaze tracking apparatus, where the neural network training apparatus and the gaze tracking apparatus are communicatively connected;

the neural network training apparatus is configured to train a neural network; and

the gaze tracking apparatus is configured to apply a neural network trained by the neural network training apparatus.

Optionally, the neural network training apparatus is configured to execute the method according to the foregoing first aspect; and the gaze tracking apparatus is configured to execute the corresponding method according to the foregoing second aspect.

In an eighth aspect, the embodiments of the present application provide a computer-readable storage medium, where the computer-readable storage medium stores instructions that, when executed on a computer, cause the computer to execute any one of the methods provided by the embodiments of the present application.

In a ninth aspect, the embodiments of the present application provide a computer program product including instructions that, when executed on a computer, cause the computer to execute any one of the methods provided by the embodiments of the present application.

### BRIEF DESCRIPTION OF DRAWINGS

To describe the technical solutions in embodiments of the present application or the background art more clearly, the accompanying drawings required for describing the embodiments of the present application or the background art are described below.

FIG. 1 shows a schematic flowchart of a gaze tracking method provided in embodiments of the present application;

FIG. 2a shows a schematic diagram of a scene of face key points provided in embodiments of the present application;

FIG. 2b shows a schematic diagram of a scene of image of the eye regions provided in embodiments of the present application;

FIG. 3 shows a schematic flowchart of a neural network training method provided in embodiments of the present application;

FIG. 4a shows a schematic flowchart of a method for determining a first gaze direction provided in embodiments of the present application;

FIG. 4b shows three schematic diagrams related to the human eyes provided in embodiments of the present application;

FIG. 4c shows a schematic diagram of determining a pupil provided in embodiments of the present application;

FIG. 5 shows a schematic flowchart of another gaze tracking method provided in embodiments of the present application;

FIG. 6 shows a schematic structural diagram of a neural network training apparatus provided in embodiments of the present application;

FIG. 7 shows a schematic structural diagram of a training unit provided in embodiments of the present application.

FIG. 8 shows a schematic structural diagram of another neural network training apparatus provided in embodiments of the present application;

FIG. 9 shows a schematic structural diagram of a detection unit provided in embodiments of the present application.

FIG. 10 shows a schematic structural diagram of an electronic device provided in embodiments of the present application.

FIG. 11 shows a schematic structural diagram of a gaze tracking apparatus provided in embodiments of the present application;

FIG. 12 shows a schematic structural diagram of another gaze tracking apparatus provided in embodiments of the present application;

FIG. 13 shows a schematic structural diagram of an electronic device provided in embodiments of the present application.

### DETAILED DESCRIPTION

To describe the purpose, the technical solutions and the advantages of the present application more clearly, the present application is further described in details below with reference to the accompanying drawings.

The terms “first”, “second”, and the like in the description, the claims, and the accompanying drawings in the present application are used for distinguishing different objects, rather than describing specific sequences. In addition, the terms “include” and “have” and any deformation thereof aim at covering non-exclusive inclusion. For example, the process, method, system, product, or device including a series of steps or units is not limited to the listed steps or units, but also optionally includes steps or units that are not listed or other steps or units inherent to the process, method, product, or device.

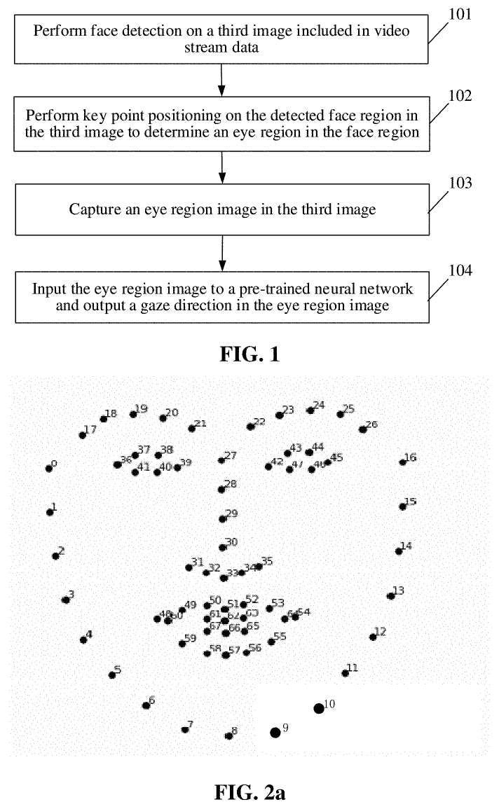

With reference to FIG. 1, FIG. 1 shows a schematic flowchart of a gaze tracking method provided in embodiments of the present application. The gaze tracking method may be applied to a gaze tracking apparatus, which may include a server and a terminal device, where the terminal device may include a mobile phone, a tablet computer, a desktop computer, a personal digital assistant, a vehicle-mounted device, a driver status monitoring system, a television, a game console, an entertainment device, an advertisement pushing device, and the like. The specific form of the gaze tracking apparatus is not uniquely limited in the embodiments of the present application.

As shown in FIG. 1, the gaze tracking method includes the following steps.

At step 101, face detection is performed on a third image included in video stream data.

In the embodiments of the present application, the third image may be any image frame in the video stream data, and the position of the face in the third image may be detected by face detection. Optionally, the gaze tracking apparatus may detect a square face image, or may detect a rectangular face image, or the like during face detection, which is not limited in the embodiments of the present application.

Optionally, the video stream data may be data captured by the gaze tracking apparatus, or may be data transmitted to the gaze tracking apparatus after being captured by other apparatuses, or the like. How the video stream data is obtained is not limited in the embodiments of the present application.

Optionally, the video stream data may be a video stream of a driving region of a vehicle captured by a vehicle-mounted camera. That is, the gaze direction output in step 104 may be the gaze direction in the image of the eye region which is a gaze direction of a driver in the driving region of the vehicle. Or, the video stream data is a video stream of a non-driving region of the vehicle captured by a vehicle-mounted camera; and the gaze direction in the image of the eye region is a gaze direction of a person in the non-driving region of the vehicle. It can be understood that the video stream data is data captured by the vehicle-mounted camera, and the vehicle-mounted camera may be directly connected to the gaze tracking apparatus, or may be indirectly connected to the gaze tracking apparatus, or the like. The form of disposing the vehicle-mounted camera is not limited in the embodiments of the present application.

It can be understood that when performing face detection on the third image included in the video stream data of the driving area of the vehicle, the gaze tracking apparatus may perform face detection in real time, or may perform face detection at a predetermined frequency or in a predetermined cycle, or the like, which is not limited in the embodiments of the present application.

However, in order to further avoid power loss of the gaze tracking apparatus and improve the efficiency of face detection, the performing face detection on a third image included in video stream data includes:

performing face detection on the third image included in the video stream data when a trigger instruction is received; or

performing face detection on the third image included in the video stream data during vehicle running; or

performing face detection on the third image included in the video stream data if the running speed of the vehicle reaches a reference speed.

The vehicle described in the embodiments of the present application includes various types of vehicles for various purposes, such as automobiles, trucks, regular buses, taxis, goods vehicles, trains, construction vehicles, and the like.

In the embodiments of the present application, the trigger instruction may be a trigger instruction input by a user received by the gaze tracking apparatus, or may be a trigger instruction sent by a terminal connected to the gaze tracking apparatus, or the like. The source of the trigger instruction is not limited in the embodiments of the present application.

In the embodiments of the present application, vehicle running may be understood as that the vehicle is started. That is, when the gaze tracking apparatus detects that the vehicle starts to run, the gaze tracking apparatus may perform face detection on any image frame (including the third image) in acquired video stream data.

In the embodiments of the present application, the reference speed is used for determining a value, where when the running speed of the vehicle reaches the value, the gaze tracking apparatus may perform face detection on the third image included in the video stream data. The reference speed may be set by a user, or may be set by a device that is connected to the gaze tracking apparatus and measures the running speed of the vehicle, or may be set by the gaze tracking apparatus, or the like, which is not limited in the embodiments of the present application.

At step 102, key point positioning is performed on the detected face region in the third image to determine an eye region in the face region.

In the embodiments of the present application, in the process of performing key point positioning, key point positioning may be performed by means of an algorithm such as an edge detection (robert) algorithm and a Sobel algorithm, or by means of a related model such as an active contour (snake) model; and key point detection and output may also be performed by a neural network used for face key point detection. Further, face key point positioning may also be performed by means of a third-party application, for example, performing face key point positioning by means of a third-party toolkit (such as dlib).

As an example, dlib is an open source toolkit having a good face key point positioning effect and is a C++ open source toolkit that includes a machine learning algorithm. At present, dlib is widely used in robotics, embedded devices, mobile phones, and large-scale high-performance computing environments. Therefore, the toolkit can be effectively used for face key point positioning to obtain face key points. Optionally, the face key points may be 68 face key points or the like. It can be understood that during positioning by means of face key point positioning, each key point has coordinates, i.e., pixel point coordinates, and therefore, an eye region may be determined according to the coordinates of the key points. Or, face key point detection may be performed through a neural network to detect 21, 106, or 240 key points.

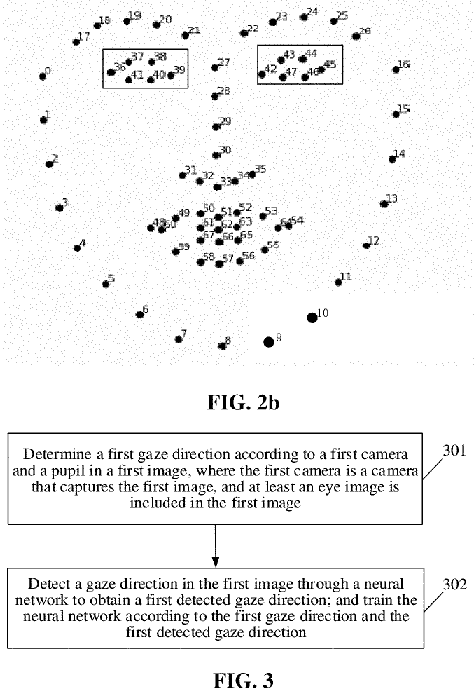

For example, as shown in FIG. 2a, FIG. 2a shows a schematic diagram of face key points provided in the embodiments of the present application. It can be seen therefrom that face key points may include key point 0, key point 1 . . . key point 67, that is, 68 key points. Among the 68 key points, key points 36-47 may be determined as an eye region. Thus, a left eye region may be determined based on key points 36 and 39, and key point 37 (or 38) and key point 40 (or 41). A right eye region may be determined based on key points 42 and 45, and key point 43 (or 44) and key point 46 (or 47), as shown in FIG. 2b. Optionally, an eye region may also be directly determined based on key points 36 and 45, and key points 37 (or 38/43/44) and 41 (or 40/46/47). It can be understood that the above is an example of determining an eye region provided in the embodiments of the present application. In specific implementation, an eye region and the like may be determined by other key points, which is not limited in the embodiments of the present application.

At step 103, an image of the eye region in the third image is captured.

In the embodiments of the present application, after the eye region in the face region is determined, an image of the eye region may be captured. Taking FIG. 2b as an example, image of the eye regions may be captured by the two rectangular boxes shown in the drawing.

It can be understood that the method for the gaze tracking apparatus to capture an image of the eye region is not limited in the embodiments of the present application, for example, capturing by screenshot software, or by drawing software, or the like.

At step 104, the image of the eye region is input to a pre-trained neural network and a gaze direction in the image of the eye region is output.

In the embodiments of the present application, the pre-trained neural network may be a neural network trained by the gaze tracking apparatus, or may be a neural network trained by other apparatuses such as a neural network training apparatus and then obtained by the gaze tracking apparatus from the neural network training apparatus. It can be understood that the method shown in FIG. 3 may be referred to for how to train a neural network, and details are not described herein again.

When implementing the embodiments of the present application, performing gaze tracking on any image frame in video stream data through a pre-trained neural network can effectively improve the accuracy of gaze tracking; further, by performing gaze tracking on any image frame in the video stream data, the gaze tracking apparatus can effectively perform other operations by means of the gaze tracking.

Optionally, when the gaze tracking apparatus includes a game console, the gaze tracking apparatus enables game interaction based on gaze tracking, thereby improving user satisfaction. When the gaze tracking apparatus includes other household appliances such as a television, the gaze tracking apparatus can perform control such as wake-up, enabling of a sleep state, and the like according to gaze tracking, for example, determining whether a user needs to turn on or off a household appliance such as a television based on the gaze direction, and the like. This is not limited in the embodiments of the present application. When the gaze tracking apparatus includes an advertisement pushing device, the gaze tracking apparatus may push an advertisement according to gaze tracking, for example, determining advertising content of interest of a user according to an output gaze direction, and then pushing an advertisement of interest of the user.

It can be understood that the above is only some examples in which the gaze tracking apparatus performs other operations according to output gaze directions provided by the embodiments of the present application, and in specific implementation, there may be other examples. Thus, the above examples should not be construed as limiting the embodiments of the present application.

It can be understood that when gaze tracking is performed on the third image included in the video stream data, there may still be some jitter occurring to the gaze direction output by the neural network. Therefore, after the inputting the image of the eye region to a pre-trained neural network and outputting the gaze direction in the image of the eye region, the method further includes:

determining a gaze direction in the third image according to the gaze direction in the image of the eye region and a gaze direction in at least one adjacent image frame of the third image.

In the embodiments of the present application, the at least one adjacent image frame may be understood as at least one image frame adjacent to the third image, for example, M image frames before the third image, or N image frames after the third image, where M and N are respectively integers greater than or equal to 1. For example, if the third image is the fifth image frame in the video stream data, the gaze tracking apparatus may determine the gaze direction in the fifth frame according to the gaze direction in the fourth frame and the gaze direction in the fifth frame.

Optionally, the average sum of the gaze direction in the image of the eye region and the gaze direction in the at least one adjacent image frame of the third image may be taken as the gaze direction in the third image, i.e., the gaze direction in the image of the eye region. In this way, the obtained gaze direction being a gaze direction predicted by the neural network after jitter can be effectively avoided, thereby effectively improving the accuracy of gaze direction prediction.

For example, if the gaze direction in the third image is (gx, gy, gz)ₙ, the third image is the N-th image frame in the video stream data, and gaze directions corresponding to the previous N−1 image frames are (gx, gy, gz)ₙ₋₁, (gx, gy, gz)ₙ₋₂, (gx, gy, gz)₁, respectively, the gaze direction in the N-th image frame, i.e., the third image, may be computed as shown in equation (1):

$$gaze = \frac{1}{n} {\sum }_{i = 2}^{n} {( gx , gy , gz )}_{i} \qquad ( 1 )$$

where “gaze” is the gaze direction in the third image.

Optionally, the gaze direction corresponding to the N-th image frame may also be calculated according to a weighted sum of the gaze direction corresponding to the N-th image frame and the gaze direction corresponding to the (N−1)-th image frame.

For another example, taking the parameters shown above as an example, the gaze direction corresponding to the N-th image frame may be calculated as shown in equation (2):

gaze=½Σᵢ₌ₙ₋₁ⁿ(gx,gy,gz)ᵢ (2)

It can be understood that the above two equations are only examples, and should not be construed as limiting the embodiments of the present application.

Implementing the embodiments of the present application can effectively prevent jitter of the gaze direction output by the neural network, thereby effectively improving the accuracy of gaze direction prediction.

The embodiments of the present application also provide a method about how to utilize the gaze direction output by the neural network, as shown below.

after the outputting the gaze direction in the image of the eye region, the method further includes:

determining a region of interest of the driver according to the gaze direction in the image of the eye region; and determining a driving behavior of the driver according to the region of interest of the driver, where the driving behavior includes whether the driver is distracted from driving; or

outputting, according to the gaze direction, control information for the vehicle or a vehicle-mounted device provided on the vehicle. Here, as an example of control of the vehicle, if the gaze falls within an air-conditioning control region for a certain period of time, a device provided on the vehicle for air conditioning is turned on or off, and as another example, if the gaze falls on a vehicle-mounted robot, the vehicle-mounted robot responds with a corresponding expression such as a smile.

In the embodiments of the present application, the gaze tracking apparatus may analyze the gaze direction of the driver according to the output gaze direction, and then may obtain an approximate region of interest of the driver. Thereby, it is possible to determine whether the driver drives the vehicle seriously according to the region of interest. In general, when a driver drives a vehicle seriously, the driver would look at the front and occasionally look around. However, if it is found that the region of interest of the driver is often not in front, it can be determined that the driver is distracted from driving.

Optionally, the gaze tracking apparatus may output warning prompt information when the gaze tracking apparatus determines that the driver is distracted from driving. In order to improve the accuracy of outputting warning prompt information and avoid causing unnecessary troubles for the driver, the outputting warning prompt information may include:

outputting the warning prompt information if the number of times the driver is distracted from driving reaches a reference number of times; or

outputting the warning prompt information if the duration during which the driver is distracted from driving reaches a reference duration; or

outputting the warning prompt information if the duration during which the driver is distracted from driving reaches the reference duration and the number of times the driver is distracted from driving reaches the reference number of times; or

transmitting prompt information to a terminal connected to the vehicle if the driver is distracted from driving.

It can be understood that the reference number of times and the reference duration are used for determining which warning prompt information is to be output by the gaze tracking apparatus. Therefore, the reference number of times and the reference duration are not specifically limited in the embodiments of the present application.

It can be understood that the gaze tracking apparatus may be wirelessly or wiredly connected to the terminal, so that the gaze tracking apparatus can transmit prompt information to the terminal to timely prompt the driver or other persons in the vehicle. The terminal is specifically a driver's terminal, or may be terminals of other persons in the vehicle, and is not uniquely limited in the embodiments of the present application.

By implementing the embodiments of the present application, the gaze tracking apparatus can analyze the gaze direction in any image frame in the video stream data for multiple times or for a long time, thereby further improving the accuracy of determining whether the driver is distracted from driving.

Further, the gaze tracking apparatus may also store one or more of the image of the eye region and a predetermined number of image frames before and after the image of the eye region if the driver is distracted from driving, or transmits one or more of the image of the eye region and the predetermined number of image frames before and after the image of the eye region to the terminal connected to the vehicle if the driver is distracted from driving.

In the embodiments of the present application, the gaze tracking apparatus may store an image of the eye region, or may store a predetermined number of image frames before and after the image of the eye region, or may simultaneously store an image of the eye region and a predetermined number of image frames before and after the image of the eye region. Thereby, it is convenient for a user to subsequently query the gaze direction. Moreover, by transmitting the above image to a terminal, the user can query the gaze direction at any time, and the user can timely obtain at least one of the image of the eye region and the predetermined number of image frames before and after the image of the eye region.

In the embodiments of the present application, in addition to detection of fatigue, distraction or other states of the driver or other persons in the vehicle, gaze tracking may also be used for interaction control, for example, outputting a control instruction according to the result of gaze tracking, where the control instruction includes, for example, lighting a screen in a region where the gaze is projected, and starting multimedia in a region where the gaze is projected, etc. In addition to the application in a vehicle, gaze tracking may also be used in scenarios such as human-machine interaction control in game, human-machine interaction control of smart home, and evaluation of advertisement delivery effects.

The neural network in the embodiments of the present application may be formed by stacking one or more network layers, such as a convolutional layer, a non-linear layer, and a pooling layer, in a certain manner. The specific network structure is not limited in the embodiments of the present application. After designing the neural network structure, thousands of iterative trainings may be performed on the designed neural network by means of back gradient propagation, etc., under supervision based on positive and negative sample images with annotation information. The specific training method is not limited in the embodiments of the present application. An optional neural network training method in the embodiments of the present application is described below.

First, the technical terms appearing in the embodiments of the present application are described.

A pick-up camera coordinate system: the origin of the pick-up camera coordinate system is the optical center of a pick-up camera, and the z-axis is the optical axis of the pick-up camera. It can be understood that the pick-up camera may also be referred to as a camera, or the pick-up camera may specifically be a Red Green Blue (RGB) camera, an infrared camera, or a near-infrared camera, etc., which is not limited in the embodiments of the present application. In the embodiments of the present application, the pick-up camera coordinate system may also be referred to as a camera coordinate system or the like. The name thereof is not limited in the embodiments of the present application. In the embodiments of the present application, the pick-up camera coordinate system includes a first coordinate system and a second coordinate system, respectively. The relationship between the first coordinate system and the second coordinate system is specifically described below.

Regarding the first coordinate system, in the embodiments of the present application, the first coordinate system is a coordinate system of any camera determined from a camera array. It can be understood that the camera array may also be referred to as a pick-up camera array or the like. The name of the camera array is not limited in the embodiments of the present application. Specifically, the first coordinate system may be a coordinate system corresponding to a first camera, or may also be referred to as a coordinate system corresponding to a first pick-up camera, or the like.

Regarding the second coordinate system, in the embodiments of the present application, the second coordinate system is a coordinate system corresponding to a second camera, that is, a coordinate system of the second camera.

For example, if cameras in the camera array are sequentially c1, c2, c3, c4, c5, c6, c7, c8, c9, c10, c11, c12, c13, . . . , c20, and the first camera is c11, the first coordinate system is a coordinate system of c11. If the second camera is c20, the second coordinate system is a coordinate system of c20.

A method for determining the relationship between the first coordinate system and the second coordinate system may be as follows:

determining a first camera from the camera array and determining a first coordinate system;

obtaining the focal length and principal point position of each camera in the camera array; and

determining the relationship between the first coordinate system and the second coordinate system according to the first coordinate system and the focal length and principal point position of each camera in the camera array.

Optionally, after determining the first coordinate system, the focal length and principal point position of each camera in the camera array may be obtained by a classic checkerboard calibration method.

For example, taking the camera array which is c1, c2, c3, c4, c5, c6, c7, c8, c9, c10, c11, c12, c13, . . . , c20 as an example, c11 (a pick-up camera placed in the center) is taken as the first pick-up camera, the first coordinate system is established, and the focal lengths f and the principal point positions (u, v) of all pick-up cameras and the rotation and translation with respect to the first camera are obtained by the classic checkerboard calibration method. A coordinate system in which each pick-up camera is located is defined as one pick-up camera coordinate system, and the positions and orientations of the remaining pick-up cameras with respect to the first pick-up camera in the first coordinate system are calculated by binocular pick-up camera calibration. Thus, the relationship between the first coordinate system and the second coordinate system can be determined.

In the embodiments of the present application, the camera array includes at least a first camera and a second camera, and the positions and orientations of the pick-up cameras are not limited in the embodiments of the present application, for example, the relationships between the cameras in the camera array may be set in such a manner that the cameras can cover the gaze range of the human eyes.

It can be understood that the above is only an example. In specific implementation, the relationship between the first coordinate system and the second coordinate system may be determined by other methods, such as a Zhang Zhengyou calibration method, and the like, which is not limited in the embodiments of the present application.

Referring to FIG. 3, FIG. 3 shows a schematic flowchart of a neural network training method provided in embodiments of the present application. The neural network training method may be applied to a gaze tracking apparatus which may include a server and a terminal device, where the terminal device may include a mobile phone, a tablet computer, a desktop computer, a personal digital assistant, and the like. The specific form of the gaze tracking apparatus is not uniquely limited in the embodiments of the present application. It can be understood that the neural network training method may also be applied to a neural network training apparatus which may include a server and a terminal device. The neural network training apparatus may be the same type of apparatus as the gaze tracking apparatus, or the neural network training apparatus may be a different type of apparatus as the gaze tracking apparatus, etc., which is not limited in the embodiments of the present application.

As shown in FIG. 3, the neural network training method includes the following steps.

At step 301, a first gaze direction is determined according to a first camera and a pupil in a first image, where the first camera is a camera that captures the first image, and at least an eye image is included in the first image includes.

In the embodiments of the present application, the first image is a 2D picture captured by a camera, and the first image is an image to be input into a neural network to train the neural network. Optionally, the number of the first images is at least two, and the number of the first images is specifically determined by the degree of training. Thus, the number of the first images is not limited in the embodiments of the present application.

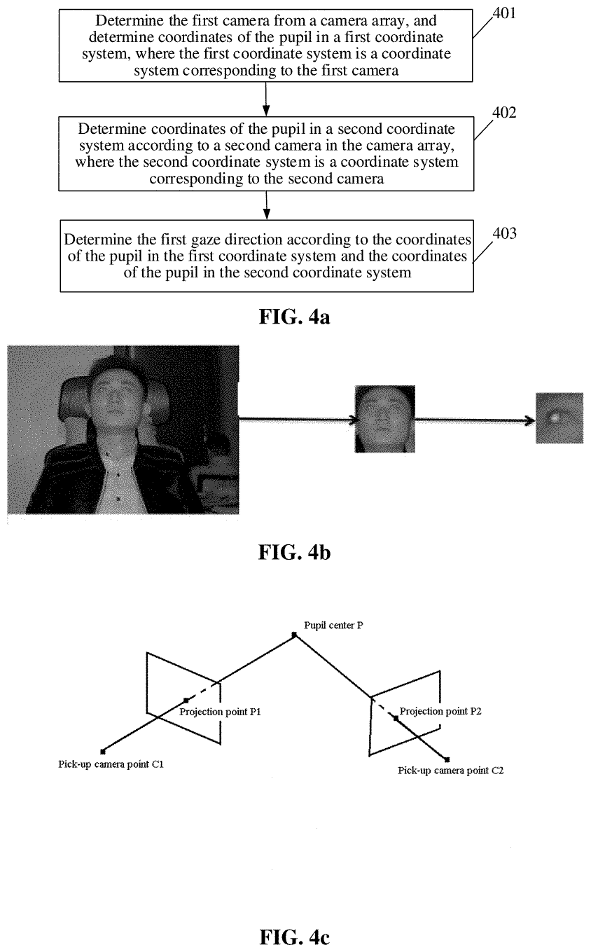

Optionally, referring to FIG. 4a, FIG. 4a shows a schematic flowchart of a method for determining a first gaze direction provided in embodiments of the present application.

At step 302, a gaze direction in the first image is detected through a neural network to obtain a first detected gaze direction; and the neural network is trained according to the first gaze direction and the first detected gaze direction.

Optionally, the first image may be an image corresponding to the pupil, that is, the first image may be an eye image, such as the image on the right shown in FIG. 4b. However, in real life, an image we get may be an image of the whole body of a person, or an image of the upper body of the person as shown on the left of FIG. 4b, or an image of the head of the person as shown in the middle of FIG. 4b. Direct input of the image into the neural network may increase the burden of neural network processing and may also interfere with the neural network.

In the embodiments of the present application, the accuracy of neural network training can be effectively improved by obtaining the first gaze direction and the first detected gaze direction.

Therefore, the embodiments of the present application further provide a method for acquiring a first image. The method for obtaining a first image may be as follows:

obtaining the position of the face in the image by means of face detection, where the proportion of the eyes in the image is greater than or equal to a preset ratio;

determining the positions of the eyes in the image by face key point positioning; and

cropping the image to obtain an image of the eyes in the image.

The image of the eyes in the image is the first image.

Optionally, since the face has a certain rotation angle, after determining the positions of the eyes in the image by face key point positioning, the horizontal axis coordinates of the inner eye corners of the two eyes may further be rotated to be equal. Therefore, after the horizontal axis coordinates of the inner eye corners of the two eyes are rotated to be equal, the eyes in the image after rotation are cropped to obtain the first image.

It can be understood that the preset ratio is set to measure the size of the eyes in the image, and is set to determine whether the acquired image needs to be cropped, etc. Therefore, the preset ratio may be specifically set by the user, or may be automatically set by the neural network training apparatus, etc., which is not limited in the embodiments of the present application. For example, if the image above is exactly an image of the eyes, the image can be directly input to the neural network. For another example, if the ratio of the eyes in the above image is one tenth, it means that the image needs to be cropped or the like to acquire the first image.

In order to improve the training effect, and improve the accuracy of the gaze direction output by the neural network, in the embodiments of the present application, the neural network may be trained according to the first gaze direction, the first detected gaze direction, a second detected gaze direction, and a second gaze direction. Thus, the detecting a gaze direction in the first image through a neural network to obtain a first detected gaze direction and training the neural network according to the first gaze direction and the first detected gaze direction includes:

detecting gaze directions in the first image and a second image through the neural network to obtain the first detected gaze direction and a second detected gaze direction, respectively, where the second image is obtained by adding noise to the first image; and

training the neural network according to the first gaze direction, the first detected gaze direction, the second detected gaze direction, and the second gaze direction, where the second gaze direction is a gaze direction obtained by adding noise to the first gaze direction.

In the embodiments of the present application, by obtaining the first detected gaze direction and the second detected gaze direction, and training the neural network according to the first gaze direction, the first detected gaze direction, the second detected gaze direction, and the second gaze direction, the accuracy of training can be improved.

It can be understood that the above neural network may include a Deep Neural Network (DNN) or a Convolutional Neural Network (CNN), and the like. The specific form of the neural network is not limited in the embodiments of the present application.

In the embodiments of the present application, if the first image is an image in video stream data, jitter may occur when acquiring the first image, that is, some jitter may occur to the gaze direction. Therefore, noise may be added to the first image for preventing jitter of the gaze direction and improving the stability of output of the neural network. A method for adding noise to the first image may include any one or more of the following: rotation, translation, scale up, and scale down. That is, the second image may be obtained by rotation, translation, scale up, scale down, and the like of the first image.

The first gaze direction is a direction in which the pupil looks at the first camera, that is, the first gaze direction is a gaze direction determined according to the pupil and the position of the camera; the first detected gaze direction is a gaze direction in the first image output by the neural network, that is, the first detected gaze direction is a gaze direction predicted by the neural network, specifically, a gaze direction predicted by the neural network and corresponding to the first image; the second detected gaze direction is a gaze direction in the first image to which noise is added, i.e., the second image, output by the neural network, that is, the second detected gaze direction is a gaze direction predicted by the neural network, specifically, a gaze direction predicted by the neural network and corresponding to the second image; the second gaze direction is a gaze direction corresponding to the second image, that is, the second gaze direction is a gaze direction obtained by conversion after the first gaze direction is subjected to the same noise addition process (which is consistent with the method for adding noise to the obtained second image).

That is to say, in the method of obtaining the gaze direction, the second gaze direction corresponds to the first gaze direction, and the first detected gaze direction corresponds to the second detected gaze direction; and in the image corresponding to the gaze direction, the first gaze direction corresponds to the first detected gaze direction, and the second detected gaze direction corresponds to the second gaze direction. It can be understood that the above description is for better understanding of the first gaze direction, the first detected gaze direction, the second detected gaze direction, and the second gaze direction.

By implementing the embodiments of the present application, the training effect of the training neural network can be effectively improved, and the accuracy of the gaze direction output by the neural network can be improved.

Further, the embodiments of the present application provide two neural network training methods as follows.

Implementation I-{ }—

The training the neural network according to the first gaze direction, the first detected gaze direction, the second detected gaze direction, and a second gaze direction includes:

adjusting network parameters of the neural network according to a third loss of the first gaze direction and the first detected gaze direction and a fourth loss of the second gaze direction and the second detected gaze direction.

The network parameters of the neural network may include a convolution kernel size or a weight parameter, etc., and the network parameters specifically included in the neural network are not limited in the embodiments of the present application.

It can be understood that before the training the neural network according to the first gaze direction, the first detected gaze direction, the second detected gaze direction, and a second gaze direction, the method further includes:

normalizing the first gaze direction, the first detected gaze direction, the second detected gaze direction, and the second gaze direction respectively.

The training the neural network according to the first gaze direction, the first detected gaze direction, the second detected gaze direction, and the second gaze direction includes:

training the neural network according to the normalized first gaze direction, the normalized second gaze direction, a normalized first detected gaze direction, and a normalized second detected gaze direction.

In the embodiments of the present application, by normalizing the first gaze direction, the first detected gaze direction, the second gaze direction, and the second detected gaze direction of the vector, the loss function can be simplified, the computing accuracy of the loss function can be improved, and the computing complexity of loss function can be avoided. The loss function may be a loss of the first gaze direction and the first detected gaze direction, may also be a loss of a first offset vector and a second offset vector, and may also be a loss of the second gaze direction and the second detected gaze direction.

That is, the network parameters of the neural network may be adjusted according to a third loss of the normalized first gaze direction and the normalized first detected gaze direction, and the fourth loss of the normalized second gaze direction and the normalized second detected gaze direction.

Assuming that the first gaze direction is (x3, y3, z3) and the first detected gaze direction is (x4, y4, z4), the mode of normalization may be as shown in equations (3) and (4):

$$normalize ground truth = ( \frac{( x 3 )}{\sqrt[2]{{( x 3 )}^{2} + {( y 3 )}^{2} + {( z 3 )}^{2}}} , \frac{( y 3 )}{\sqrt[2]{{( x 3 )}^{2} + {( y 3 )}^{2} + {( z 3 )}^{2}}} , \frac{( z 3 )}{\sqrt[2]{{( x 3 )}^{2} + {( y 3 )}^{2} + {( z 3 )}^{2}}} ) \qquad ( 3 )$$

where normalize ground truth is the normalized first gaze direction.

$$normalize prediction gaze = ( \frac{( x 4 )}{\sqrt[2]{{( x 4 )}^{2} + {( y 4 )}^{2} + {( z 4 )}^{2}}} , \frac{( y 4 )}{\sqrt[2]{{( x 4 )}^{2} + {( y 4 )}^{2} + {( z 4 )}^{2}}} , \frac{( z 4 )}{\sqrt[2]{{( x 4 )}^{2} + {( y 4 )}^{2} + {( z 4 )}^{2}}} ) \qquad ( 4 )$$

where normalize ground truth is the normalized first detected gaze direction.

The third loss may be calculated as shown in equation (5):

loss=∥normalize ground truth−normalize prediction gaze∥ (5)

where “loss” is the third loss.

It can be understood that the above expressions by the various letters or parameters are merely examples, and should not be construed as limiting the embodiments of the present application.

By normalizing the first gaze direction, the first detected gaze direction, the second gaze direction, and the second detected gaze direction, the influence of the magnitude in each gaze direction can be eliminated, so that only the gaze direction is focused on, and thus, the accuracy of training the neural network can be further improved.

Implementation II

The training the neural network according to the first gaze direction, the first detected gaze direction, the second detected gaze direction, and a second gaze direction includes:

determining a first loss of the first gaze direction and the first detected gaze direction;

determining a second loss of a first offset vector and a second offset vector, where the first offset vector is an offset vector between the first gaze direction and the second gaze direction, and the second offset vector is an offset vector between the first detected gaze direction and the second detected gaze direction; and adjusting network parameters of the neural network according to the first loss and the second loss.

In the embodiments of the present application, the neural network is trained not only according to the loss of the first gaze direction and the first detected gaze direction, but also according to the loss of the first offset vector and the second offset vector. By enhancing the input image data, not only the problem of gaze jitter during the gaze tracking process can be effectively prevented, but also the stability and accuracy of training the neural network can be improved.

Assuming that the first gaze direction is (x3, y3, z3), the first detected gaze direction is (x4, y4, z4), the second detected gaze direction is (x5, y5, z5), and the second gaze direction is (x6, y6, z6), the first offset vector is (x3-x6, y3-y6, z3-z6), and the second offset vector is (x4-x5, y4-y5, z4-z5).

It can be understood that before the training the neural network according to the first gaze direction, the first detected gaze direction, the second detected gaze direction, and a second gaze direction, the method further includes:

normalizing the first gaze direction, the first detected gaze direction, the second detected gaze direction, and the second gaze direction respectively.

The training the neural network according to the first gaze direction, the first detected gaze direction, the second detected gaze direction, and the second gaze direction includes:

training the neural network according to the normalized first gaze direction, the normalized second gaze direction, a normalized first detected gaze direction, and a normalized second detected gaze direction.

In the embodiments of the present application, by normalizing the first gaze direction, the first detected gaze direction, the second gaze direction, and the second detected gaze direction of the vector, the loss function can be simplified, the computing accuracy of the loss function can be improved, and the computing complexity of loss function can be avoided. The loss function may be a loss of the first gaze direction and the first detected gaze direction, may also be a loss of the first offset vector and the second offset vector, and may also be a loss of the second gaze direction and the second detected gaze direction.

That is, the network parameters of the neural network may be adjusted according to the first loss of the normalized first gaze direction and the normalized first detected gaze direction and the second loss of a normalized first offset vector and a normalized second offset vector. The normalized first offset vector is an offset vector between the normalized first gaze direction and the normalized second gaze direction, and the normalized second offset vector is an offset vector between the normalized first detected gaze direction and the normalized second detected gaze direction.

For the specific implementation of normalization, reference may be made to the implementation shown in implementation I, and details are not described herein again.

By normalizing the first gaze direction, the first detected gaze direction, the second gaze direction, and the second detected gaze direction, the influence of the magnitude in each gaze direction can be eliminated, so that only the gaze direction is focused on, and thus, the accuracy of training the neural network can be further improved.

In a possible implementation, before the normalizing the first gaze direction, the first detected gaze direction, the second detected gaze direction, and the second gaze direction respectively, the method further includes:

determining eye positions in the first image; and

rotating the first image according to the eye positions so that the two eye positions in the first image are the same on a horizontal axis.

It can be understood that, in the embodiments of the present application, determining the eye positions in the first image may specifically include determining a left eye position and a right eye position in the first image respectively, capturing an image corresponding to the left eye position and an image corresponding to the left eye position, and then respectively rotating the image corresponding to the right eye position and the image corresponding to the left eye position to make the two eye positions the same on the horizontal axis.

It can be understood that, in order to further improve the smoothness of the gaze direction, the detecting, by the neural network, the gaze direction in the first image to obtain the first directed gaze direction includes:

respectively detecting gaze directions in N adjacent image frames through the neural network if the first image is a video image, where N is an integer greater than or equal to 1; and

determining the gaze direction in the N-th image frame as the first detected gaze direction according to the gaze directions in the N adjacent image frames.

The specific value of N is not limited in the embodiments of the present application. The N adjacent image frames may be N image frames before the N-th image frame (including the N-th frame), or may be N image frames after the N-th image frame, or may be N image frames before and after the N-th image frame, and the like, which is not limited in the embodiments of the present application.

In the embodiments of the present application, in gaze tracking in a video, there may still be jitter occurring to the gaze direction output by the neural network. Therefore, by determining the gaze direction in the N-th image frame according to the gaze directions in N image frames, and performing a smoothing process based on the gaze direction detected by the neural network, the stability of the gaze direction detected by the neural network can be improved.

Optionally, the gaze direction in the N-th image frame may be determined according to an average sum of the gaze directions in N adjacent image frames, so as to smooth the gaze direction, making the obtained first detected gaze direction more stable.

It can be understood that the method for determining the second detected gaze direction may also be obtained by the method described above, and details are not described herein again.

In the embodiments of the present application, by obtaining the first detected gaze direction and the second detected gaze direction and training the neural network according to the first gaze direction, the first detected gaze direction, and the second detected gaze direction, on the one hand, the accuracy of training the neural network can be improved, and on the other hand, the neural network can be trained efficiently.

It can be understood that after the neural network is obtained by neural network training by the above method, the neural network training apparatus may directly apply the neural network to predict the gaze direction, or the neural network training apparatus may also transmit the trained neural network to other apparatuses so that other apparatuses utilize the trained neural network to predict the gaze direction. Which apparatuses the neural network training apparatus specifically transmits the neural network to are not limited in the embodiments of the present application.

Referring to FIG. 4a, FIG. 4a shows a schematic flowchart of a method for determining a first gaze direction provided in embodiments of the present application. As shown in FIG. 4a, the method for determining a first gaze direction includes the following steps.

At step 401, the first camera is determined from a camera array, and coordinates of the pupil in a first coordinate system are determined, where the first coordinate system is a coordinate system corresponding to the first camera.

In the embodiments of the present application, the coordinates of the pupil in the first coordinate system may be determined according to the focal length and principal point position of the first camera.

Optionally, the determining the coordinates of the pupil in the first coordinate system includes:

determining coordinates of the pupil in the first image; and

determining the coordinates of the pupil in the first coordinate system according to the coordinates of the pupil in the first image and the focal length and principal point position of the first camera.

In the embodiments of the present application, for a captured 2D picture of the eyes, i.e., the first image, points around the edge of the pupil of an eye may be extracted directly by a network model for detecting edge points of the pupil, and the coordinates of the pupil position, such as (m, n), are then calculated according to the points around the edge of the pupil. The calculated coordinates (m, n) of the pupil position may also be understood as the coordinates of the pupil in the first image, and may also be understood as the coordinates of the pupil in a pixel coordinate system.

Assuming that the focal length of the camera that captures the first image, i.e., the first camera, is f, and the principal point position thereof is (u, v), the coordinates of a point at which the pupil is projected onto an imaging plane of the first camera in the first coordinate system is (m-u, n-v, f).

At step 402, coordinates of the pupil in a second coordinate system are determined according to a second camera in the camera array, where the second coordinate system is a coordinate system corresponding to the second camera.

The determining the coordinates of the pupil in the second coordinate system according to the second camera in the camera array includes:

determining the relationship between the first coordinate system and the second coordinate system according to the first coordinate system and the focal length and principal point position of each camera in the camera array; and

determining the coordinates of the pupil in the second coordinate system according to the relationship between the second coordinate system and the first coordinate system.

In the embodiments of the present application, for the method for determining the relationship between the first coordinate system and the second coordinate system, reference may be made to the description in the foregoing embodiments, and details are not described herein again. After the coordinates of the pupil in the first coordinate system are obtained, the coordinates of the pupil in the second coordinate system may be obtained according to the relationship between the first coordinate system and the second coordinate system.

At step 403, the first gaze direction is determined according to the coordinates of the pupil in the first coordinate system and the coordinates of the pupil in the second coordinate system.

It can be understood that, in the embodiments of the present application, the first camera may be any camera in the camera array. Optionally, the first camera is at least two cameras. In other words, at least two first cameras may be used to capture two first images, and the coordinates of the pupil under any one of the at least two first cameras are respectively obtained (specifically refer to the foregoing description); and further, the coordinates in the respective coordinate systems may be integrated into the second coordinate system. Therefore, after determining sequentially the coordinates of the pupil in the first coordinate system and the coordinates of the pupil in the second coordinate system, the coordinates in the same coordinate system may be obtained based on the property that the three points, i.e., the camera, the projection point of the pupil, and the pupil, are on the same line. The coordinates of the pupil (i.e., the pupil center in FIG. 4c) in the second coordinate system are the common intersection of the straight lines, as shown in FIG. 4c.

Optionally, the gaze direction may be defined as the direction of a line connecting the camera position and the eye position. Optionally, the calculation equation of the first gaze direction is as shown in equation (6):

gaze=(x1-x2,y1-y2,z1-z2) (6)

where gaze is the first gaze direction, (x1, y1, z1) is the coordinates of the first camera in the coordinate system c, and (x2, y2, z2) is the coordinates of the pupil in the coordinate system c.

In the embodiments of the present application, the coordinate system c is not limited, for example, the coordinate system c may be the second coordinate system, or the coordinate system may be any coordinate system in the first coordinate system or the like.

It can be understood that the above is only one method for determining the first gaze direction provided by the embodiments of the present application. In specific implementation, other methods may be included, and details are not described herein again.

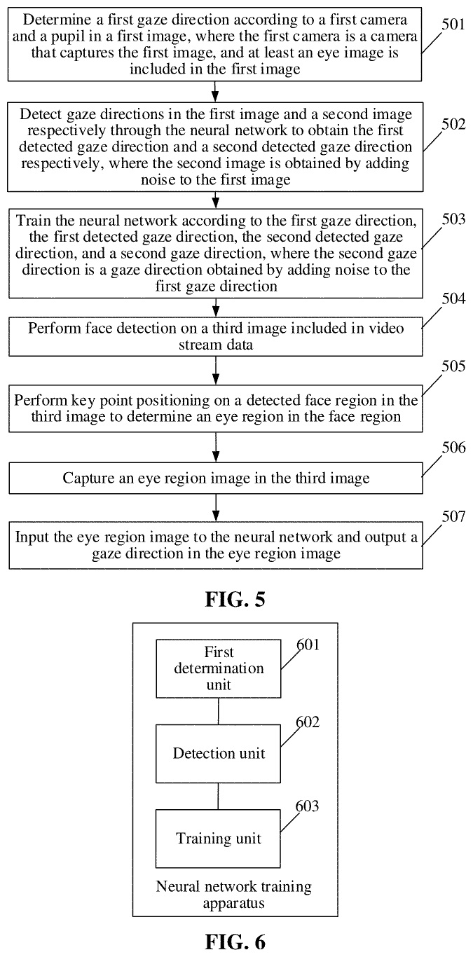

Referring to FIG. 5, FIG. 5 shows a schematic flowchart of another gaze tracking method provided in embodiments of the present application. As shown in FIG. 5, the gaze tracking method includes the following steps.

At step 501, a first gaze direction is determined according to a first camera and a pupil in a first image, where the first camera is a camera that captures the first image, and at least an eye image is included in the first image includes.

At step 502, gaze directions in the first image and a second image are detected through a neural network to obtain a first detected gaze direction and a second detected gaze direction, respectively, where the second image is obtained by adding noise to the first image.

At step 503, the neural network is trained according to the first gaze direction, the first detected gaze direction, the second detected gaze direction, and a second gaze direction, where the second gaze direction is a gaze direction obtained by adding noise to the first gaze direction.

It can be understood that, for the specific implementation of steps 501-503, reference may be made to the specific implementation of the neural network training method shown in FIG. 3, and details are not described herein again.

At step 504, face detection is performed on a third image included in video stream data.

In the embodiments of the present application, for eye gaze tracking in a video, a gaze direction corresponding to each image frame may be obtained according to the trained neural network.

At step 505, key point positioning is performed on the detected face region in the third image to determine an eye region in the face region.

At step 506, an image of the eye region in the third image is captured.

At step 507, the image of the eye region is input to the neural network and a gaze direction in the image of the eye region is output.

It can be understood that the neural network trained in the embodiments of the present application may also be applied to gaze tracking in picture data, and details are not described herein again.

It can be understood that, for the specific implementation of steps 504-507, reference may be made to the specific implementation of the gaze tracking method shown in FIG. 1, and details are not described herein again.

It can be understood that the specific implementation shown in FIG. 5 may correspond to the methods shown in FIG. 1, FIG. 3 and FIG. 4a, and details are not described herein again.

By implementing the embodiments of the present application, the neural network is trained by means of the first gaze direction, the first detected gaze direction, the second gaze direction, and the second detected gaze direction, thereby effectively improving the accuracy of neural network training, and further effectively improving the accuracy of prediction of the gaze direction in a third image.

The above various embodiments are described with different emphasis, for the implementation that is not described in detail in one embodiment, reference may be made to other embodiments, and details are not described herein again.

The methods according to the embodiments of the present application are described in detail above, and the apparatuses according to the embodiments of the present application are provided below.

Referring to FIG. 6, FIG. 6 shows a schematic structural diagram of a neural network training apparatus provided in embodiments of the present application. As shown in FIG. 6, the neural network training apparatus may include:

a first determination unit 601, configured to determine a first gaze direction according to a first camera and a pupil in a first image, where the first camera is a camera that captures the first image, and the first image includes at least an eye image;

a detection unit 602, configured to detect a gaze direction in the first image through a neural network to obtain a first detected gaze direction; and

a training unit 603, configured to train the neural network according to the first gaze direction and the first detected gaze direction.

By implementing the embodiments of the present application, the accuracy of training can be improved by obtaining the first detected gaze direction and training the neural network according to the first gaze direction and the first detected gaze direction.

Optionally, the detection unit 602 is specifically configured to detect gaze directions in the first image and a second image through the neural network to obtain the first detected gaze direction and a second detected gaze direction, respectively, where the second image is obtained by adding noise to the first image; and

the training unit 603 is specifically configured to train the neural network according to the first gaze direction, the first detected gaze direction, the second detected gaze direction, and a second gaze direction, where the second gaze direction is a gaze direction obtained by adding noise to the first gaze direction.

Optionally, the training unit 603 is specifically configured to adjust network parameters of the neural network according to a third loss of the first gaze direction and the first detected gaze direction and a fourth loss of the second gaze direction and the second detected gaze direction.

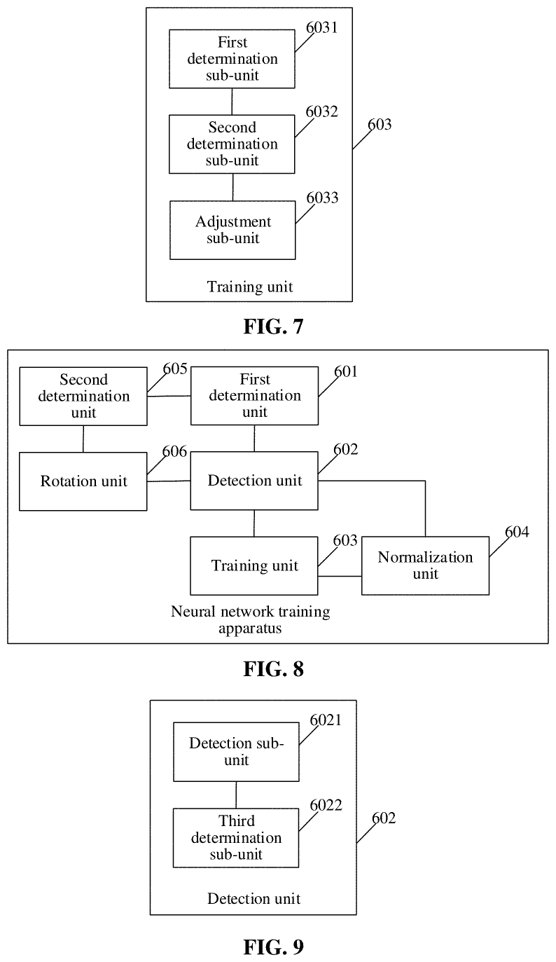

Optionally, as shown in FIG. 7, the training unit 603 includes:

a first determination sub-unit 6031, configured to determine a first loss of the first gaze direction and the first detected gaze direction;

a second determination sub-unit 6032, configured to determine a second loss of a first offset vector and a second offset vector, where the first offset vector is an offset vector between the first gaze direction and the second gaze direction, and the second offset vector is an offset vector between the first detected gaze direction and the second detected gaze direction; and

an adjustment sub-unit 6033, configured to adjust the network parameters of the neural network according to the first loss and the second loss.

Optionally, as shown in FIG. 8, the apparatus further includes:

a normalization unit 604, configured to normalize the first gaze direction, the first detected gaze direction, the second detected gaze direction, and the second gaze direction respectively; and

the training unit 603, specifically configured to train the neural network according to the normalized first gaze direction, the normalized second gaze direction, a normalized first detected gaze direction, and a normalized second detected gaze direction.

Optionally, as shown in FIG. 8, the apparatus further includes:

a second determination unit 605, configured to determine eye positions in the first image; and

a rotation unit 606, configured to rotate the first image according to the eye positions so that the two eye positions in the first image are the same on a horizontal axis.

Optionally, as shown in FIG. 9, the detection unit 602 includes:

a detection sub-unit 6021, configured to respectively detect gaze directions in N adjacent image frames through the neural network if the first image is a video image, where N is an integer greater than or equal to 1; and

a third determination sub-unit 6022, configured to determine the gaze direction in the N-th image frame as the first detected gaze direction according to the gaze directions in the N adjacent image frames.

Optionally, the third determination sub-unit 6022 is specifically configured to determine the gaze direction in the N-th image frame as the first detected gaze direction according to the average sum of the gaze directions in the N adjacent image frames.

Optionally, the first determination unit 601 is specifically configured to: determine the first camera from a camera array, and determine coordinates of the pupil in a first coordinate system, where the first coordinate system is a coordinate system corresponding to the first camera; determine coordinates of the pupil in a second coordinate system according to a second camera in the camera array, where the second coordinate system is a coordinate system corresponding to the second camera; and determine the first gaze direction according to the coordinates of the pupil in the first coordinate system and the coordinates of the pupil in the second coordinate system.

Optionally, the first determination unit 601 is specifically configured to: determine coordinates of the pupil in the first image; and determine the coordinates of the pupil in the first coordinate system according to the coordinates of the pupil in the first image and the focal length and principal point position of the first camera.

Optionally, the first determination unit 601 is specifically configured to: determine the relationship between the first coordinate system and the second coordinate system according to the first coordinate system and the focal length and principal point position of each camera in the camera array; and determine the coordinates of the pupil in the second coordinate system according to the relationship between the second coordinate system and the first coordinate system.

It should be noted that, for the implementation of each unit and the technical effects of the apparatus embodiments, reference may also be made to the corresponding description above or in the method embodiments shown in FIGS. 3-5.

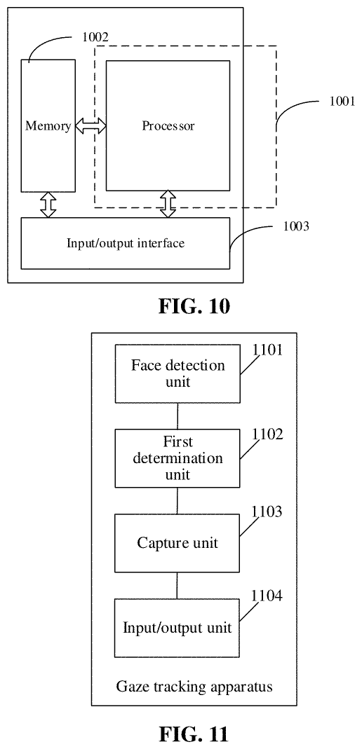

Referring to FIG. 10, FIG. 10 shows a schematic structural diagram of an electronic device provided in embodiments of the present application. As shown in FIG. 10, the electronic device includes a processor 1001, a memory 1002, and an input/output interface 1003. The processor 1001, the memory 1002, and the input/output interface 1003 are connected to each other through a bus.

The input/output interface 1003 may be used to input data and/or signals, and output data and/or signals.

The memory 1002 includes, but is not limited to, a Random Access Memory (RAM), a Read-Only Memory (ROM), an Erasable Programmable Read Only Memory (EPROM), or a Compact Disc Read-Only Memory (CD-ROM), and is used for related instructions and data.

The processor 1001 may be one or more Central Processing Units (CPUs). If the processor 1001 is one CPU, the CPU may be a single-core CPU or a multi-core CPU.

Optionally, for the implementation of each operation, reference may also be made to the corresponding description in the method embodiments shown in FIGS. 3-5. Or, for the implementation of each operation, reference may also be made to the corresponding description in the embodiments shown in FIGS. 6-9.

For example, in one embodiment, the processor 1001 is used to execute the method shown in steps 301 and 302, and for another example, the processor 1001 is also used to execute the method executed by the first determination unit 601, the detection unit 602, and the training unit 603.

Referring to FIG. 11, FIG. 11 shows a schematic structural diagram of a gaze tracking apparatus provided in embodiments of the present application. The gaze tracking apparatus may be used to execute the corresponding methods shown in FIGS. 1-5. As shown in FIG. 11, the gaze tracking apparatus includes:

a face detection unit 1101, configured to perform face detection on a third image included in video stream data;

a first determination unit 1102, configured to perform key point positioning on the detected face region in the third image to determine an eye region in the face region;

a capture unit 1103, configured to capture an image of the eye region in the third image; and

an input/output unit 1104, configured to input the image of the eye region to a pre-trained neural network and output a gaze direction in the image of the eye region.

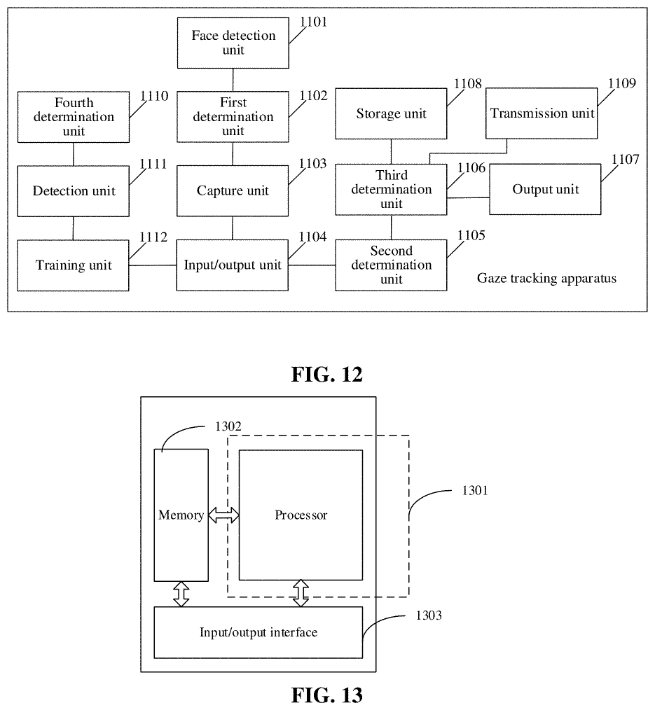

Optionally, as shown in FIG. 12, the gaze tracking apparatus further includes:

a second determination unit 1105, configured to determine a gaze direction in the third image according to the gaze direction in the image of the eye region and a gaze direction in at least one adjacent image frame of the third image.

Optionally, the face detection unit 1101 is specifically configured to perform face detection on the third image included in the video stream data when a trigger instruction is received; or

the face detection unit 1101 is specifically configured to perform face detection on the third image included in the video stream data during vehicle running; or

the face detection unit 1101 is specifically configured to perform face detection on the third image included in the video stream data if the running speed of the vehicle reaches a reference speed.

Optionally, the video stream data is a video stream of a driving region of the vehicle captured by a vehicle-mounted camera, and the gaze direction in the image of the eye region is a gaze direction of a driver in the driving region of the vehicle; or, the video stream data is a video stream of a non-driving region of the vehicle captured by a vehicle-mounted camera, and the gaze direction in the image of the eye region is a gaze direction of a person in the non-driving region of the vehicle.

Optionally, as shown in FIG. 12, the apparatus further includes:

a third determination unit 1106, configured to: determine a region of interest of the driver according to the gaze direction in the image of the eye region; and determine a driving behavior of the driver according to the region of interest of the driver, where the driving behavior includes whether the driver is distracted from driving; or

an output unit 1107, configured to output, according to the gaze direction, control information for the vehicle or a vehicle-mounted device provided on the vehicle.

Optionally, as shown in FIG. 12, the output unit 1107 is configured to output warning prompt information if the driver is distracted from driving.

Optionally, the output unit 1107 is specifically configured to output the warning prompt information if the number of times the driver is distracted from driving reaches a reference number of times; or

the output unit 1107 is specifically configured to output the warning prompt information if the duration during which the driver is distracted from driving reaches a reference duration; or

the output unit 1107 is specifically configured to output the warning prompt information if the duration during which the driver is distracted from driving reaches the reference duration and the number of times the driver is distracted from driving reaches the reference number of times; or

the output unit 1107 is specifically configured to transmit prompt information to a terminal connected to the vehicle if the driver is distracted from driving.

As shown in FIG. 12, the apparatus further includes:

a storage unit 1108, configured to store one or more of the image of the eye region and a predetermined number of image frames before and after the image of the eye region if the driver is distracted from driving; or

a transmission unit 1109, configured to transmit one or more of the image of the eye region and the predetermined number of image frames before and after the image of the eye region to the terminal connected to the vehicle if the driver is distracted from driving.

Optionally, as shown in FIG. 12, the apparatus further includes:

a fourth determination unit 1110, configured to determine a first gaze direction according to a first camera and a pupil in a first image, where the first camera is a camera that captures the first image, and the first image includes at least an eye image;

a detection unit 1111, configured to detect a gaze direction in the first image through a neural network to obtain a first detected gaze direction; and

a training unit 1112, configured to train the neural network according to the first gaze direction and the first detected gaze direction.

Optionally, it should be noted that, for the implementation of each unit and the technical effects of the apparatus embodiments, reference may also be made to the corresponding description above or in the method embodiments shown in FIGS. 1-5.

It can be understood that for the specific implementations of the fourth determination unit, the detection unit, and the training unit, reference may also be made to the methods shown in FIGS. 6 and 8, and details are not described herein again.

Referring to FIG. 13, FIG. 13 shows a schematic structural diagram of an electronic device provided in embodiments of the present application. As shown in FIG. 13, the electronic device includes a processor 1301, a memory 1302, and an input/output interface 1303. The processor 1301, the memory 1302, and the input/output interface 1303 are connected to each other through a bus.

The input/output interface 1303 may be used to input data and/or signals, and output data and/or signals.

The memory 1302 includes, but is not limited to, a RAM, a ROM, an EPROM, or a CD-ROM, and is used for related instructions and data.

The processor 1301 may be one or more CPUs. If the processor 1301 is one CPU, the CPU may be a single-core CPU or a multi-core CPU.

Optionally, for the implementation of each operation, reference may also be made to the corresponding description in the method embodiments shown in FIGS. 1-5. Or, for the implementation of each operation, reference may also be made to the corresponding description in the embodiments shown in FIGS. 11 and 12.

For example, in one embodiment, the processor 1301 is used to execute the method shown in steps 101-104, and for another example, the processor 1301 is also used to execute the method executed by the face detection unit 1101, the first determination unit 1102, the capture unit 1103, and the input/output unit 1104.

It can be understood that, for the implementation of each operation, reference may also be made to other embodiments, and details are not described herein again.

It should be understood that the disclosed system, apparatus, and method in the embodiments provided in the present application may be implemented by other modes. For example, the unit division is merely logical function division and may be other division in actual implementation. For example, a plurality of units or components may be combined or integrated into another system, or some features may be ignored or not performed. The displayed or discussed mutual couplings or direct couplings or communication connections may be implemented by means of some interfaces. The indirect couplings or communication connections between the apparatuses or units may be implemented in electronic, mechanical, or other forms.

The units described as separate parts may or may not be physically separate, and the parts displayed as units may or may not be physical units, may be located at one position, or may be distributed on a plurality of network units. A part of or all of the units may be selected according to actual needs to achieve the objectives of the solutions of the embodiments.

The foregoing embodiments may be implemented in whole or in part by using software, hardware, firmware, or any combination of software, hardware, and firmware. When implemented by software, the embodiments may be implemented in whole or in part in the form of a computer program product. The computer program product includes one or more computer instructions. When the computer program instruction(s) is/are loaded and executed on a computer, the processes or functions in accordance with the embodiments of the present application are generated in whole or in part. The computer may be a general-purpose computer, a special-purpose computer, a computer network, or other programmable apparatuses. The computer instruction(s) may be stored in or transmitted over a computer-readable storage medium. The computer instruction(s) may be transmitted from one website site, computer, server, or data center to another website site, computer, server, or data center in a wired (e.g., a coaxial cable, optical fiber, Digital Subscriber Line (DSL)) or wireless (e.g. infrared, wireless, microwave, etc.) manner. The computer-readable storage medium may be any available medium that can be accessed by a computer or a data storage device such as a server, a data center, or the like that includes one or more available media integrated thereon. The available medium may be a ROM, or a RAM, or a magnetic medium such as a floppy disk, a hard disk, a magnetic tape, a magnetic disk, or an optical medium such as a Digital Versatile Disc (DVD), or a semiconductor medium such as a Solid State Disk (SSD), etc.

1. A gaze tracking method, comprising:
performing face detection on a third image comprised in video stream data;
performing key point positioning on a detected face region in the third image to determine an eye region in the detected face region;
capturing an image of the eye region in the third image; and
inputting the image of the eye region to a pre-trained neural network and outputting a gaze direction in the image of the eye region.

2. The method according to claim 1, wherein after the inputting the image of the eye region to a pre-trained neural network and outputting a gaze direction in the image of the eye region, the method further comprises:
determining a gaze direction in the third image according to the gaze direction in the image of the eye region and a gaze direction in at least one adjacent image frame of the third image.

3. The method according to claim 1, wherein the performing face detection on a third image comprised in video stream data comprises:
performing face detection on the third image comprised in the video stream data when a trigger instruction is received; or
performing face detection on the third image comprised in the video stream data during vehicle running; or
performing face detection on the third image comprised in the video stream data if a running speed of the vehicle reaches a reference speed.

4. The method according to claim 3, wherein
the video stream data is a video stream of a driving region of the vehicle captured by a vehicle-mounted camera, and the gaze direction in the image of the eye region is a gaze direction of a driver in the driving region of the vehicle; or, the video stream data is a video stream of a non-driving region of the vehicle captured by a vehicle-mounted camera, and the gaze direction in the image of the eye region is a gaze direction of a person in the non-driving region of the vehicle.

5. The method according to claim 4, wherein after the outputting a gaze direction in the image of the eye region, the method further comprises:
determining a region of interest of the driver according to the gaze direction in the image of the eye region; determining a driving behavior of the driver according to the region of interest of the driver, wherein the driving behavior comprises whether the driver is distracted from driving; or outputting, according to the gaze direction, control information for the vehicle or a vehicle-mounted device provided on the vehicle.

6. The method according to claim 5, further comprising:
outputting warning prompt information if the driver is distracted from driving.

7. The method according to claim 6, wherein the outputting warning prompt information comprises:
outputting the warning prompt information if the number of times the driver is distracted from driving reaches a reference number of times; or
outputting the warning prompt information if the duration during which the driver is distracted from driving reaches a reference duration; or
outputting the warning prompt information if the duration during which the driver is distracted from driving reaches the reference duration and the number of times the driver is distracted from driving reaches the reference number of times; or
transmitting prompt information to a terminal connected to the vehicle if the driver is distracted from driving.

8. The method according to claim 6, further comprising:
storing one or more of the image of the eye region and a predetermined number of image frames before and after the image of the eye region if the driver is distracted from driving; or
transmitting one or more of the image of the eye region and the predetermined number of image frames before and after the image of the eye region to a terminal connected to the vehicle if the driver is distracted from driving.

9. The method according to claim 1, wherein before the inputting the image of the eye region to a pre-trained neural network, the method further comprises:
determining a first gaze direction according to a first camera and a pupil in a first image, wherein the first camera is a camera that captures the first image, and at least an eye image is comprised in the first image;
detecting a gaze direction in the first image through a neural network to obtain a first detected gaze direction; and
training the neural network according to the first gaze direction and the first detected gaze direction.

10. The method according to claim 9, wherein the detecting a gaze direction in the first image through a neural network to obtain a first detected gaze direction comprises:
detecting gaze directions in the first image and a second image respectively through the neural network to obtain the first detected gaze direction and a second detected gaze direction respectively, wherein the second image is obtained by adding noise to the first image; and
the training the neural network according to the first gaze direction and the first detected gaze direction comprises:
training the neural network according to the first gaze direction, the first detected gaze direction, the second detected gaze direction, and a second gaze direction, wherein the second gaze direction is a gaze direction obtained by adding noise to the first gaze direction.

11. The method according to claim 10, wherein the training the neural network according to the first gaze direction, the first detected gaze direction, the second detected gaze direction, and a second gaze direction comprises:
determining a first loss of the first gaze direction and the first detected gaze direction;
determining a second loss of a first offset vector and a second offset vector, wherein the first offset vector is an offset vector between the first gaze direction and the second gaze direction, and the second offset vector is an offset vector between the first detected gaze direction and the second detected gaze direction; and
adjusting network parameters of the neural network according to the first loss and the second loss.

12. The method according to claim 10, wherein the training the neural network according to the first gaze direction, the first detected gaze direction, the second detected gaze direction, and a second gaze direction comprises:
adjusting network parameters of the neural network according to a third loss of the first gaze direction and the first detected gaze direction and a fourth loss of the second gaze direction and the second detected gaze direction.

13. The method according to claim 11, wherein before the training the neural network according to the first gaze direction, the first detected gaze direction, the second detected gaze direction, and a second gaze direction, the method further comprises:
normalizing the first gaze direction, the first detected gaze direction, the second detected gaze direction, and the second gaze direction respectively; and
the training the neural network according to the first gaze direction, the first detected gaze direction, the second detected gaze direction, and the second gaze direction comprises:
training the neural network according to the normalized first gaze direction, the normalized second gaze direction, a normalized first detected gaze direction, and a normalized second detected gaze direction.

14. The method according to claim 13, wherein before the normalizing the first gaze direction, the first detected gaze direction, the second detected gaze direction, and the second gaze direction respectively, the method further comprises:
determining eye positions in the first image; and
rotating the first image according to the eye positions so that the two eye positions in the first image are the same on a horizontal axis.

15. The method according to claim 9, wherein the detecting a gaze direction in the first image through a neural network to obtain a first detected gaze direction comprises:
respectively detecting gaze directions in N adjacent image frames through the neural network if the first image is a video image, wherein N is an integer greater than or equal to 1; and
determining the gaze direction in the N-th image frame as the first detected gaze direction according to an average sum of the gaze directions in the N adjacent image frames.

16. The method according to claim 9, wherein the determining a first gaze direction according to a first camera and a pupil in the first image comprises:
determining the first camera from a camera array, and determining coordinates of the pupil in a first coordinate system, wherein the first coordinate system is a coordinate system corresponding to the first camera;
determining coordinates of the pupil in a second coordinate system according to a second camera in the camera array, wherein the second coordinate system is a coordinate system corresponding to the second camera; and
determining the first gaze direction according to the coordinates of the pupil in the first coordinate system and the coordinates of the pupil in the second coordinate system.

17. The method according to claim 16, wherein the determining coordinates of the pupil in a first coordinate system comprises:
determining coordinates of the pupil in the first image; and
determining the coordinates of the pupil in the first coordinate system according to the coordinates of the pupil in the first image and a focal length and principal point position of the first camera.

18. The method according to claim 16, wherein the determining coordinates of the pupil in a second coordinate system according to a second camera in the camera array comprises:
determining a relationship between the first coordinate system and the second coordinate system according to the first coordinate system and a focal length and principal point position of each camera in the camera array; and
determining the coordinates of the pupil in the second coordinate system according to the relationship between the second coordinate system and the first coordinate system.

19. An electronic device, comprising a processor and a memory which are connected to each other by a line, wherein the memory is used for storing program instructions, when the program instructions are executed by the processor, the processor is configured to:
perform face detection on a third image comprised in video stream data;
perform key point positioning on a detected face region in the third image to determine an eye region in the detected face region;
capture an image of the eye region in the third image; and
input the image of the eye region to a pre-trained neural network and output a gaze direction in the image of the eye region.

20. A computer-readable storage medium, which stores a computer program therein, wherein the computer program comprises program instructions that, when executed by a processor, cause the processor to execute the following operations:
performing face detection on a third image comprised in video stream data;
performing key point positioning on a detected face region in the third image to determine an eye region in the detected face region;
capturing an image of the eye region in the third image; and
inputting the image of the eye region to a pre-trained neural network and outputting a gaze direction in the image of the eye region.
